(19) United States
(12) Patent Application Publication
(10) Pub. No.: US 2025/0100485 A1
(43) Pub. Date: Mar. 27, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP); Eri Ueda, Makinohara-shi (JP)

(21) Appl. No.: 18/893,895

(22) Filed: Sep. 23, 2024

(30) Foreign Application Priority Data
Sep. 26, 2023 (JP) 2023-163173

(51) Int. Cl. B60R 16/027; B60J 7/02; B60R 16/02

(52) U.S. Cl. CPC B60R 16/027; B60J 7/02; B60R 16/0215

(57) ABSTRACT

A routing structure includes a first fixing portion fixed to a vehicle body of a vehicle, a second fixing portion fixed to a slide body that moves along a vehicle front-rear direction at an opening provided in a roof of the vehicle body, an exterior member having a first end portion held by the first fixing portion and a second end portion held by the second fixing portion, an electric wire disposed inside the exterior member, and an urging member disposed inside the exterior member and having a curved portion curved in a vehicle front-rear direction between the first end portion and the second end portion in the exterior member.

### CROSS-REFERENCE TO RELATED APPLICATION(S)

The present application claims priority to and incorporates by reference the entire contents of Japanese Patent Application No. 2023-163173 filed in Japan on Sep. 26, 2023.

### BACKGROUND OF THE INVENTION

### 1. Field of the Invention

The present invention relates to a routing structure.

### 2. Description of the Related Art

In the related art, there is a power feeding device for a slide body. Japanese Patent Application Laid-open No. 2011-151906 discloses a power feeding device for a slide body including a wire harness routed over a vehicle body and a slide body that is slidably provided in the vehicle body and opens and closes an opening formed in the vehicle body.

When the routing structure between the vehicle body and the slide body includes an exterior member, it is desirable that the shape of the exterior member is stable. For example, the exterior member is held by the slide body and the vehicle body in a state of having a curved portion curved in a sliding direction of the slide body. When the bending R of the curved portion changes according to the movement of the slide body, the shape of the exterior member may be unstable due to vibration or its own weight.

### SUMMARY OF THE INVENTION

An object of the present invention is to provide a routing structure capable of stabilizing a shape of an exterior member.

In order to achieve the above mentioned object, a routing structure according to one aspect of the present invention includes a first fixing portion fixed to a vehicle body of a vehicle; a second fixing portion fixed to a slide body that moves along a vehicle front-rear direction at an opening provided in a roof of the vehicle body; an exterior member having a first end portion held by the first fixing portion and a second end portion held by the second fixing portion; an electric wire disposed inside the exterior member; and an urging member disposed inside the exterior member and having a curved portion curved in a vehicle front-rear direction between the first end portion and the second end portion of the exterior member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to an embodiment;

FIG. 2 is a side view of the routing structure according to the embodiment;

FIG. 3 is a cross-sectional view of the routing structure according to the embodiment;

FIG. 4 is a side view of the routing structure according to the embodiment;

FIG. 5 is a cross-sectional view of the routing structure according to the embodiment;

FIG. 6 is a view for describing deformation of an urging member;

FIG. 7 is a cross-sectional view of the routing structure according to the embodiment;

FIG. 8 is a view for describing deformation of an electric wire;

FIG. 9 is a view for describing deformation of the electric wire;

FIG. 10 is a plan view of an urging member according to a modification of the embodiment;

FIG. 11 is a cross-sectional view of the urging member according to the modification of the embodiment;

FIG. 12 is a view for explaining bending R of the urging member; and

FIG. 13 is a side view of a routing structure according to the modification of the embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiments include those that can be easily assumed by those skilled in the art or those that are substantially the same.

### EMBODIMENTS

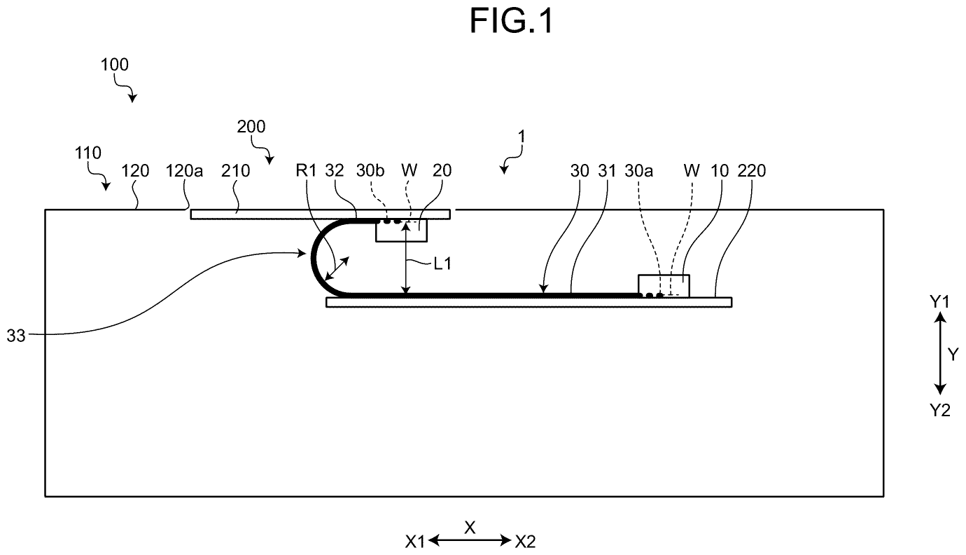

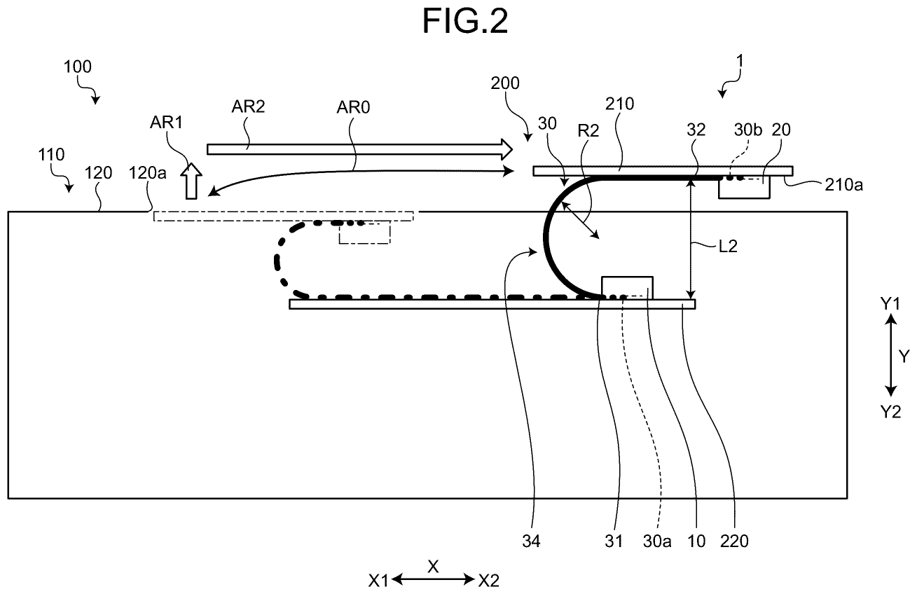

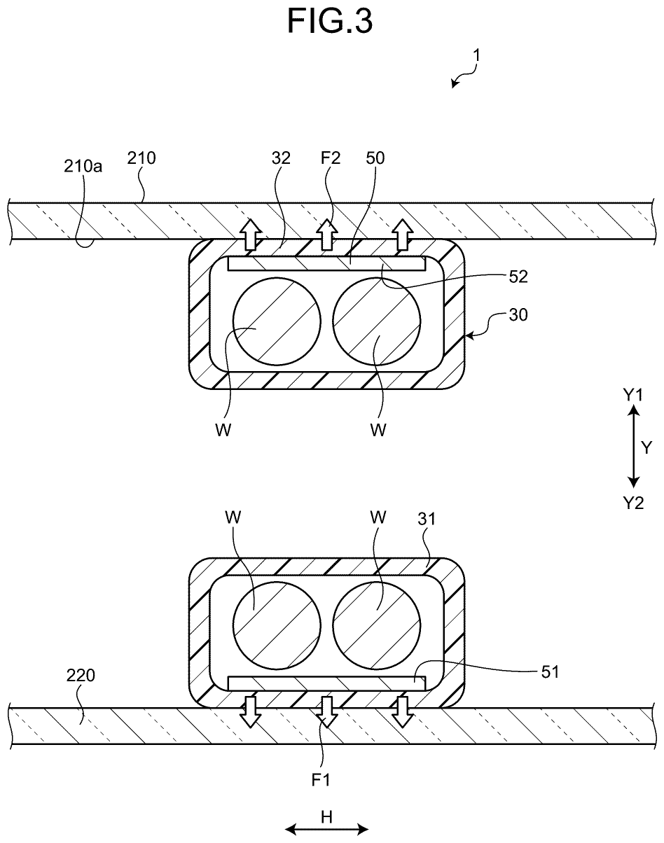

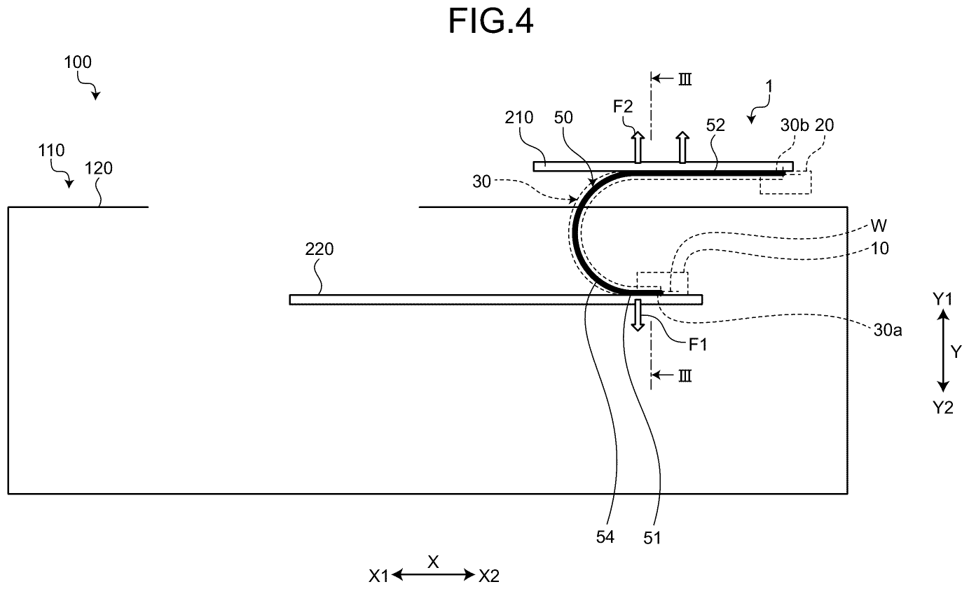

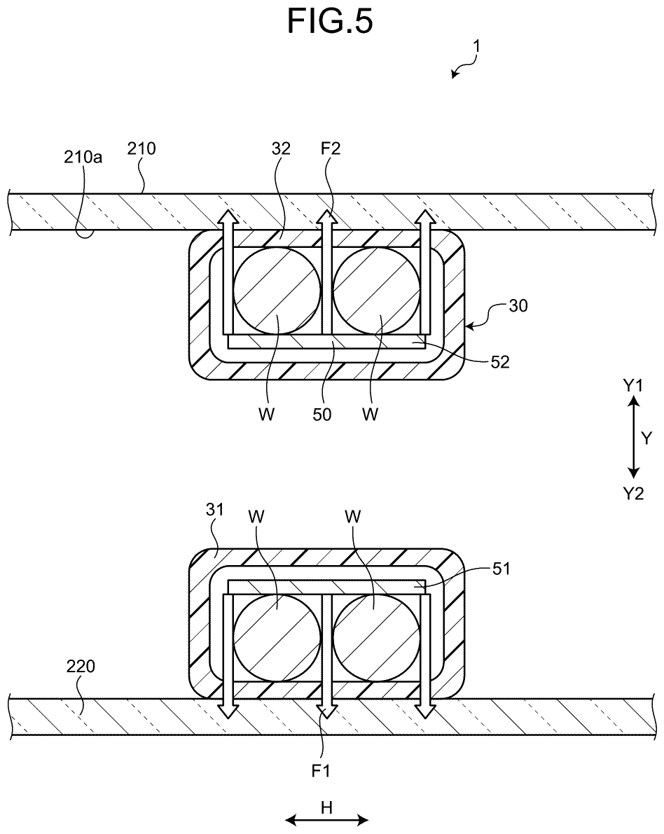

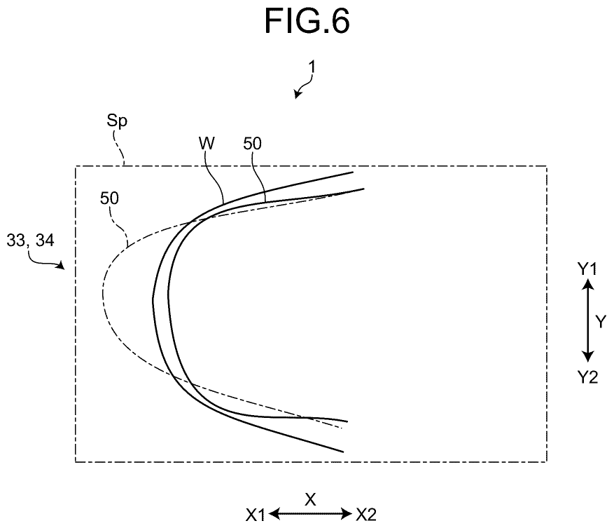

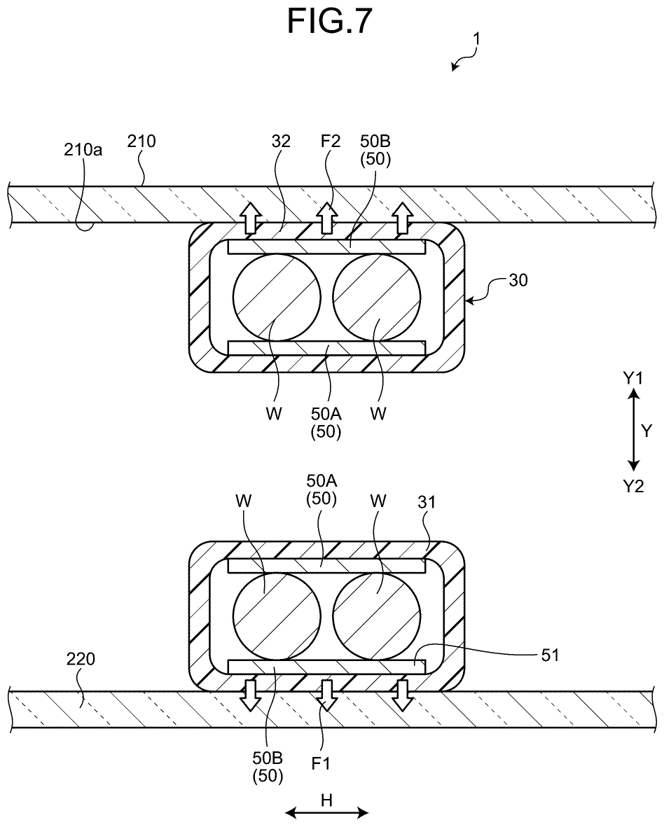

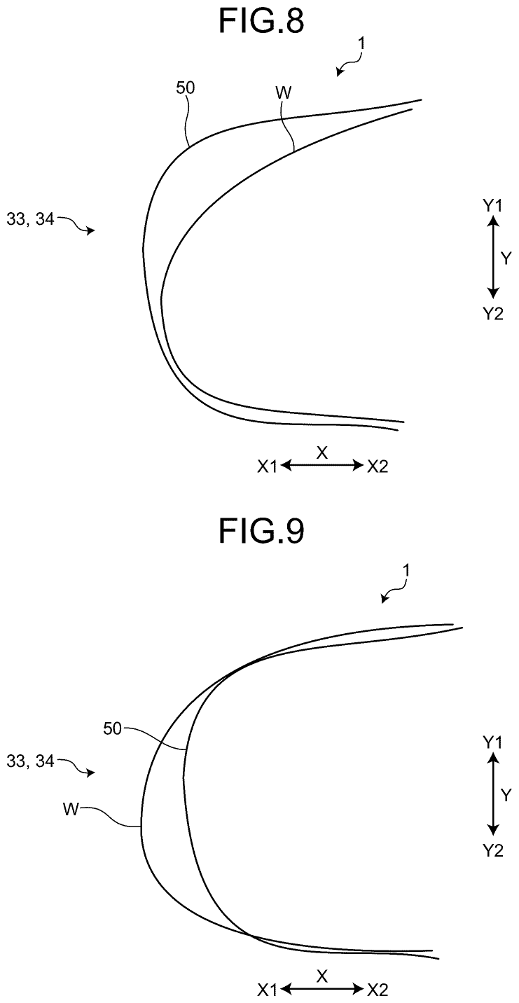

An embodiment will be described with reference to FIGS. 1 to 9. The present embodiment relates to a routing structure. FIGS. 1 and 2 are side views of a routing structure according to an embodiment, FIG. 3 is a cross-sectional view of the routing structure according to an embodiment, FIG. 4 is a side view of the routing structure according to an embodiment, FIG. 5 is a cross-sectional view of the routing structure according to an embodiment, FIG. 6 is a view for describing deformation of an urging member, FIG. 7 is a cross-sectional view of the routing structure according to an embodiment, and FIGS. 8 and 9 are views for describing deformation of an electric wire. FIG. 3 illustrates a cross section taken along line III-III in FIG. 4.

As illustrated in FIG. 1, a routing structure 1 of the embodiment is applied to a sunroof 200 of a vehicle 100. The vehicle 100 is, for example, an automobile on which a power source such as a motor or an engine is mounted. The vehicle 100 includes a vehicle body 110. The vehicle body 110 has a roof 120 that covers the vehicle interior. The roof 120 has an opening 120a that opens upward.

The vehicle 100 includes the sunroof 200 that opens and closes the opening 120a. The sunroof 200 includes a slide body 210, a rail 220, and the routing structure 1. The slide body 210 is a member that slides along the vehicle front-rear direction X with respect to the opening 120a. The slide body 210 of the present embodiment is a plate-like member that closes the opening 120a or opens the opening 120a. The slide body 210 may be glass configured to transmit light.

The sunroof 200 includes a mechanism such as a link mechanism that moves the slide body 210 along a predetermined path, and a drive source such as a motor that operates the above mechanism. The sunroof 200 moves the slide body 210 between a fully closed position where the opening 120a is closed and a fully open position where the opening 120a is opened. FIG. 1 illustrates the slide body 210 at a fully closed position. FIG. 2 illustrates the slide body 210 at a fully open position.

The rail 220 is fixed to the vehicle body 110. The rail 220 extends in the vehicle front-rear direction X. The rail 220 supports a mechanism for moving the slide body 210, and guides the mechanism in the vehicle front-rear direction X. The rail 220 further supports an exterior member 30 and the exterior member 30 has a first extension portion 31 at the rail 220.

The sunroof 200 of the present embodiment moves the slide body 210 along a path AR0 illustrated in FIG. 2. The movement of the slide body 210 along the path AR0 includes movement along the vehicle front-rear direction X and movement along vehicle vertical direction Y. When the slide body 210 moves from the fully closed position to the fully open position, the slide body 210 moves upward Y1 in the vehicle vertical direction Y and moves rearward X2 in the vehicle front-rear direction X as indicated by an arrow AR1 in FIG. 2.

Conversely, when the slide body 210 moves from the fully open position to the fully closed position, the slide body 210 moves frontward X1 in the vehicle front-rear direction X and moves downward Y2 in the vehicle vertical direction Y.

As illustrated in FIGS. 1 to 3, the routing structure 1 includes a first fixing portion 10, a second fixing portion 20, the exterior member 30, an electric wire W, and an urging member 50. The exterior member 30 and the electric wire W constitute a wire harness routed between the vehicle body 110 and the slide body 210.

The first fixing portion 10 is a member fixed to the vehicle body 110 of the vehicle 100. The first fixing portion 10 may be a protector that protects the electric wire W. The first fixing portion 10 is formed of, for example, insulating synthetic resin. The first fixing portion 10 has a space in which the electric wire W is routed and has a holding structure for holding the exterior member 30.

The second fixing portion 20 is a member fixed to the slide body 210 of the sunroof 200. The second fixing portion 20 may be a protector that protects the electric wire W. The second fixing portion 20 is formed of, for example, insulating synthetic resin. The second fixing portion 20 has a space in which the electric wire W is routed and has a holding structure for holding the exterior member 30.

The exterior member 30 is an elastically deformable tubular member. The exterior member 30 is, for example, a member called a corrugated tube. The exterior member 30 is formed of, for example, an insulating synthetic resin. The exterior member 30 may have a bellows shape.

The exterior member 30 has a first end portion 30a held by the first fixing portion 10 and a second end portion 30b held by the second fixing portion 20. The first fixing portion 10 holds the first end portion 30a such that the exterior member 30 extends from the first fixing portion 10 along the rail 220 in the vehicle front-rear direction X. In the present embodiment, the first fixing portion 10 holds the first end portion 30a such that the exterior member 30 extends frontward X1 from the first fixing portion 10.

The second fixing portion 20 holds the second end portion 30b such that the exterior member 30 extends from the second fixing portion 20 along the slide body 210 in the vehicle front-rear direction X. In the present embodiment, the second fixing portion 20 holds the second end portion 30b such that the exterior member 30 extends frontward X1 from the second fixing portion 20.

The electric wire W and the urging member 50 are disposed inside the exterior member 30. The electric wire W is, for example, a sheathed electric wire having a stranded wire and a sheath. The electric wire W may be a flat routing member, a printed circuit body, or another circuit body. The electric wire W drawn out from the first end portion 30a is connected to a power supply and a control device disposed in the vehicle body 110. The electric wire W drawn out from the second end portion 30b is connected to a load disposed at the slide body 210. The load disposed at the slide body 210 may be, for example, a lighting device, a light adjusting film disposed on the glass of the slide body 210, or another electric load.

As illustrated in FIGS. 1 and 2, the exterior member 30 has curved portions 33 and 34 that are curved in the vehicle front-rear direction X between the first end portion 30a and the second end portion 30b. The curved portion 33 illustrated in FIG. 1 is a curved portion of the exterior member 30 in a state where the slide body 210 is at the fully closed position. The curved portion 33 has a radius R1. The curved portion 34 illustrated in FIG. 2 is a curved portion of the exterior member 30 in a state where the slide body 210 is at the fully open position. The curved portion 34 has a radius R2. The electric wire W in which the curved portions 33 and 34 are formed has a U shape or a J shape.

As illustrated in FIG. 1, when the slide body 210 is at the fully closed position, a distance to the second end portion 30b from the first end portion 30a in the vehicle vertical direction Y is a first distance L1. The radius R1 of the curved portion 33 is half the first distance L1.

As illustrated in FIG. 2, when the slide body 210 is at the fully open position, a distance to the second end portion 30b from the first end portion 30a in the vehicle vertical direction Y is a second distance L2. The radius R2 of the curved portion 34 is half the second distance L2.

The second end portion 30b of the exterior member 30 moves together with the slide body 210. At this time, the exterior member 30 follows the movement of the second fixing portion 20 while gradually changing the position where the curved shape is formed.

The urging member 50 of the present embodiment has rigidity capable of pressing the exterior member 30 against the slide body 210. The urging member 50 is a rod-like or plate-like member and is elastically deformable. The urging member 50 is made of metal or resin.

As illustrated in FIGS. 3 and 4, the cross-sectional shape of the exterior member 30 of the present embodiment is rectangular. The illustrated shape of the urging member 50 is a flat plate shape. The cross-sectional shape of the urging member 50 orthogonal to the axis direction of the urging member 50 is rectangular. The urging member 50 extends from one end to the other end in the width direction H in the internal space of the exterior member 30. The urging member 50 faces each of the plurality of electric wires W in the vehicle vertical direction Y. In other words, the urging member 50 has a width capable of supporting the plurality of electric wires W.

The urging member 50 in FIG. 3 is disposed outside relative to the electric wire W. Therefore, in the curved portions 33 and 34, the urging member 50 is located radially outside relative to the electric wire W. As illustrated in FIG. 3, the urging member 50 comes into contact with the exterior member 30, and applies pressing forces F1 and F2 to the exterior member 30 at the contact face.

As illustrated in FIG. 4, the exterior member 30, the electric wire W, and the urging member 50 are routed in a state of being curved in a U shape or a J shape. That is, the urging member 50 extends from the first fixing portion 10 to the second fixing portion 20 in a state of having a curved portion 54.

The urging member 50 bent so as to have the curved portion 54 applies the pressing force F1 and the pressing force F2 to the exterior member 30. The pressing force F1 is a force in the vehicle vertical direction Y, and presses the exterior member 30 against the rail 220. The pressing force F2 is a force in the vehicle vertical direction Y, and presses the exterior member 30 against the slide body 210. The pressing forces F1 and F2 are restoring forces generated in the bent urging member 50.

The pressing force F1 forms the first extension portion 31 of the exterior member 30. The pressing force F2 forms a second extension portion 32 of the exterior member 30. As illustrated in FIG. 2 and the like, the second extension portion 32 is a portion extending along a vehicle interior side face 210a of the slide body 210. The vehicle interior side face 210a is a face facing downward Y2. When the vehicle interior side face 210a is a flat face, the second extension portion 32 is formed linearly. When the vehicle interior side face 210a has a curved shape, the second extension portion 32 has a curved shape along the vehicle interior side face 210a.

The urging member 50 of the present embodiment is configured to press the exterior member 30 against the slide body 210 when the slide body 210 is at the fully closed position and when the slide body 210 is at the fully open position. In other words, the urging member 50 has rigidity that allows the exterior member 30 to be constantly pressed against and in contact with the slide body 210. Therefore, the routing structure 1 of the present embodiment can stabilize the shape of the exterior member 30. The urging member 50 can bring the exterior member 30 into contact with the slide body 210 against an external force such as vibration generated during traveling, for example.

The urging member 50 may be disposed so as to be located radially inside relative to the electric wire W in the curved portion. FIG. 5 illustrates the urging member 50 disposed inside relative to the electric wire W. The urging member 50 located at the first extension portion 31 of the exterior member 30 applies the pressing force F1 to the exterior member 30 and the electric wire W. That is, the pressing force F1 of the urging member 50 is applied to the exterior member 30 via the electric wire W. The urging member 50 located at the second extension portion 32 of the exterior member 30 applies the pressing force F2 to the exterior member 30 and the electric wire W. That is, the pressing force F2 of the urging member 50 is applied to the exterior member 30 via the electric wire W.

When the urging member 50 is disposed inside relative to the electric wire W, the urging member 50 has an appropriate bending R as described below. FIG. 6 illustrates the urging member 50 and the electric wire W when viewed in the width direction H. In FIG. 6, the urging member 50 indicated by a one-dot chain line indicates a curved shape when the urging member 50 is bent alone. When the urging member 50 has high rigidity, the bending R of the urging member 50 decreases in a case where the urging member 50 is bent inside the narrow space Sp. In other words, the curved portion of the urging member 50 tends to have a tapered shape.

When the electric wire W is disposed outside the urging member 50, the electric wire W supports the curved portion of the urging member 50. The electric wire W can increase the bending R of the urging member 50 as compared with that when the urging member 50 is bent alone. Therefore, bending durability of the urging member 50 is improved.

The urging member 50 may be disposed inside and outside relative to the electric wire W. FIG. 7 illustrates the urging members 50 disposed on both sides of the electric wire W. The routing structure 1 illustrated in FIG. 7 includes a first urging member 50A and a second urging member 50B. The first urging member 50A is disposed inside relative to the electric wire W. The second urging member 50B is disposed outside relative to the electric wire W. That is, the electric wire W is sandwiched between the first urging member 50A and the second urging member 50B inside the exterior member 30.

When the urging members 50A and 50B are disposed on both sides of the electric wire W, the bending R of the electric wire W is stabilized as described below. FIG. 8 illustrates the shape of the electric wire W when one urging member 50 is disposed outside relative to the electric wire W. As illustrated in FIG. 8, when the electric wire W is disposed inside relative to the urging member 50, the electric wire W may be away from the urging member 50 due to the weight of the electric wire W or the like.

FIG. 9 illustrates the shape of the electric wire W when one urging member 50 is disposed inside relative to the electric wire W. As illustrated in FIG. 9, when the electric wire W is disposed outside relative to the urging member 50, the electric wire W may be away from the urging member 50 due to tolerance. When the electric wire W is separated from the urging member 50, the bending R of the electric wire W is likely to deviate from a target size.

By disposing the electric wire W between the two urging members 50A and 50B, the bending R of the electric wire W is controlled to a target size. In addition, by generating a bending reaction force by the two urging members 50A and 50B, it is possible to reduce the thickness of the urging members 50A and 50B.

As described above, the routing structure 1 of the present embodiment includes the first fixing portion 10, the second fixing portion 20, the exterior member 30, the electric wire W, and the urging member 50. The first fixing portion 10 is fixed to the vehicle body 110 of the vehicle 100. The second fixing portion 20 is fixed to the slide body 210. The slide body 210 moves along the vehicle front-rear direction X with respect to the opening 120a provided in the roof 120 of the vehicle body 110. The exterior member 30 has a first end portion 30a held by the first fixing portion 10 and a second end portion 30b held by the second fixing portion 20. The electric wire W and the urging member 50 are disposed inside the exterior member 30.

The urging member 50 forms the curved portions 33 and 34 curved in the vehicle front-rear direction X between the first end portion 30a and the second end portion 30b of the exterior member 30. In the routing structure 1 of the present embodiment, the shapes of the curved portions 33 and 34 can be stabilized by the urging member 50.

In the curved portions 33 and 34 of the exterior member 30, the urging member 50 may be located radially inside relative to the electric wire W. In this case, the electric wire W supports the curved portion of the urging member 50, and the urging member 50 can have an appropriate bending R.

The routing structure 1 may include two urging members 50A and 50B. In the curved portions 33 and 34 of the exterior member 30, the first urging member 50A is located radially inside, and the second urging member 50B is located radially outside relative to the electric wire W. With such a configuration, the bending R of the electric wire W is controlled to a target size.

In the curved portions 33 and 34 of the exterior member 30, the urging member 50 may be located radially outside relative to the electric wire W. In this case, the pressing forces F1 and F2 are transmitted from the urging member 50 to the exterior member 30 without through the electric wire W.

### Modification of Embodiment

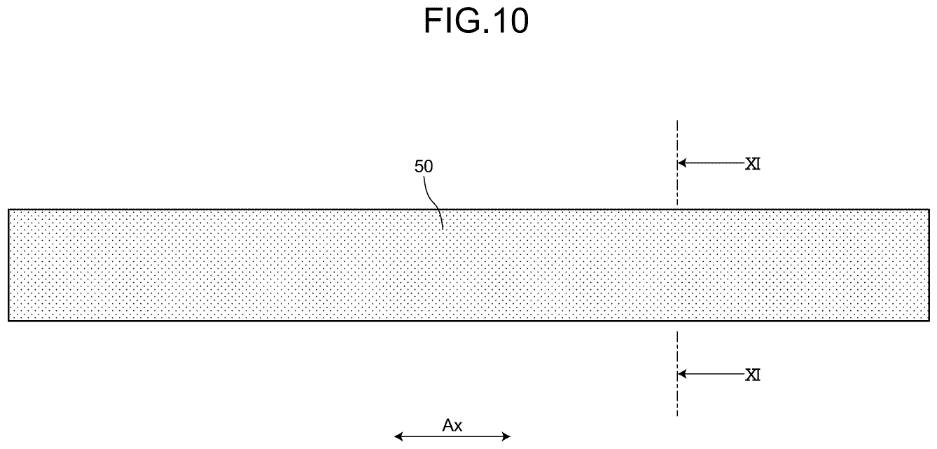

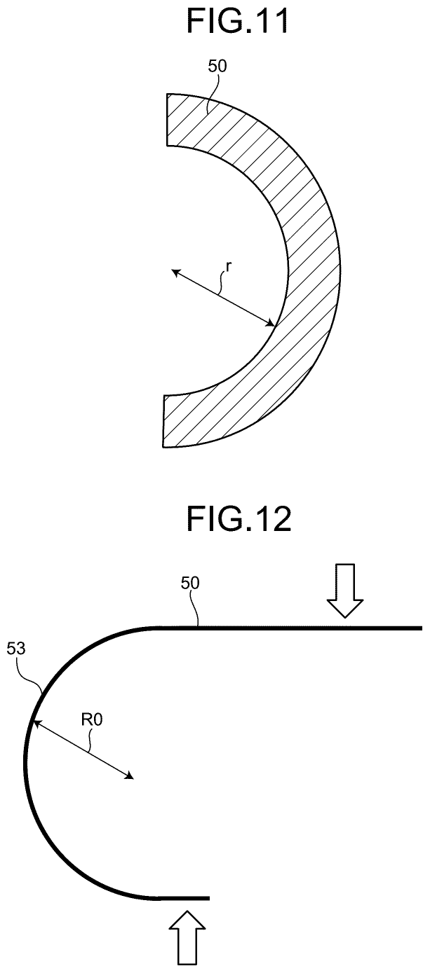

A modification of the embodiment will be described. FIG. 10 is a plan view of an urging member according to a modification of the embodiment, FIG. 11 is a cross-sectional view of the urging member according to the modification of the embodiment, and FIG. 12 is a view for describing a bending R of the urging member. The modification of the embodiment is different from the above embodiment in that, for example, the urging member 50 has a curved cross-sectional shape. FIG. 11 illustrates a cross section taken along line XI-XI in FIG. 10.

As illustrated in FIG. 10, the urging member 50 is a plate-like member and has an axis direction Ax. The axis direction Ax is a longitudinal direction of the urging member 50. The urging member 50 is, for example, a metal plate. As illustrated in FIG. 11, the cross-sectional shape of the urging member 50 orthogonal to the axis direction Ax is an arc shape. The cross section of the urging member 50 has an arc shape with a radius r. In the urging member 50 having a curved cross-sectional shape, the size of the bending R is determined according to the radius r of the cross section.

As illustrated in FIG. 12, when the urging member 50 is bent alone, the urging member 50 has a curved portion 53. A radius R0 of the curved portion 53 corresponds to the radius r of the cross section. When the radius r of the cross section is small, the urging member 50 has the curved portion 53 having a small value of the radius R0, and when the radius r of the cross section is large, the urging member 50 has the curved portion 53 having a large value of the radius R0. That is, the value of the radius R0 of the curved portion 53 can be controlled by the radius r.

The radius r of the cross section is determined according to, for example, a distance in the vehicle vertical direction Y between the first end portion 30a and the second end portion 30b of the exterior member 30. The radius r of the cross section may be determined corresponding to the second distance L2 at the fully open position illustrated in FIG. 2. FIG. 12 illustrates the urging member 50 folded back so as to form the arc-shaped curved portion 53. The value of the radius r of the cross section is set such that, for example, when the urging member 50 is folded back as shown in FIG. 12, the urging member 50 has curved shape having the second distance L2 as a diameter. In other words, the design value of the radius r of the cross section is determined so that the following Formula (1) is realized.

$$R 0 = R 2 = L 2 / 2 \qquad ( 1 )$$

When the radius r of the cross section is determined as described above, as illustrated in FIG. 2, the exterior member 30 when fully opened has the curved portion 34 having the radius R2. The size of the radius R2 at this time is determined by the radius r of the cross section of the urging member 50.

When the slide body 210 is at the fully closed position, the exterior member 30 has the curved portion 33 as illustrated in FIG. 1. The radius R1 of the curved portion 33 is smaller than a size determined by the radius r of the cross section. The radius R1 of the curved portion 33 is determined by the first distance L1. That is, when the distance L between the first end portion 30a and the second end portion 30b is smaller than the second distance L2, the urging member 50 has the bending R corresponding to the distance L. As described above, in the urging member 50, the bending R of the exterior member 30 can be set to the maximum size corresponding to the distance L when the sunroof 200 is fully closed, fully opened, and opened and closed. As in the sunroof 200 of the above embodiment, the sunroof 200 of the modification moves the slide body 210 such that the second distance L2 is larger than the first distance L1.

The radius r of the cross section may be determined corresponding to the first distance L1 at the fully closed position illustrated in FIG. 1, for example. In this case, the value of the radius r of the cross section is set such that, for example, when the urging member 50 is folded back as shown in FIG. 12, the urging member 50 has curved shape having the first distance L1 as a diameter. In other words, the design value of the radius r of the cross section is determined so that the following Formula (2) is realized.

$$R 0 = R 1 = L 1 / 2 \qquad ( 2 )$$

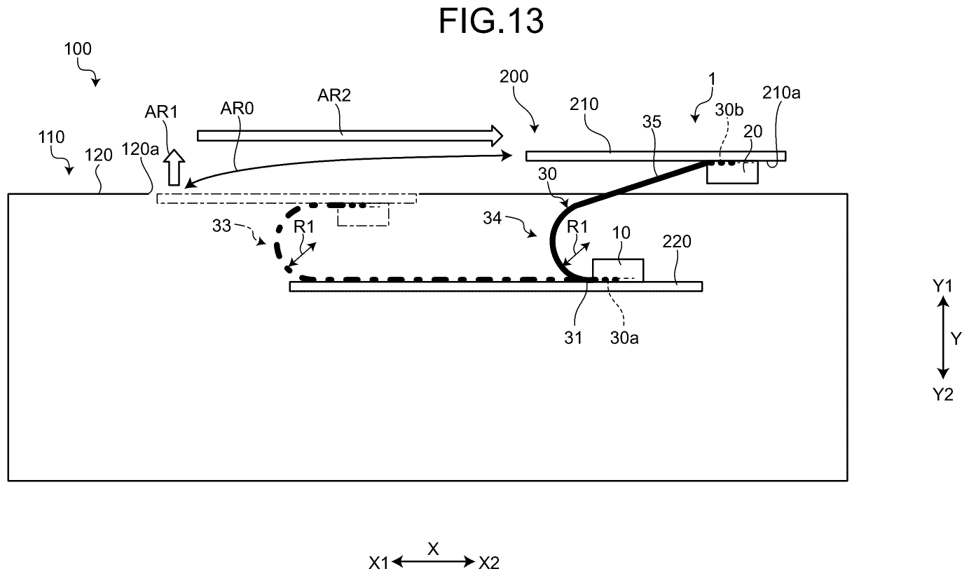

When the radius r of the cross section is determined as described above, as illustrated in FIG. 13, the exterior member 30 when fully opened has the curved portion 34 having the radius R1. The radius R1 of the curved portion 34 is determined by the radius r of the cross section of the urging member 50. When the slide body 210 is at the fully open position, the exterior member 30 has an inclined portion 35. The inclined portion 35 is a portion extending from the curved portion 34 to the second fixing portion 20, and is inclined with respect to the vehicle front-rear direction X.

When the slide body 210 is at the fully closed position, the exterior member 30 has a curved portion 33 having radius R1 in as illustrated in FIG. 1. The radius R1 of the curved portion 33 is determined by the radius r of the cross section.

When the radius r of the cross section is determined so as to realize Formula (2), the wire harness can be minimized. That is, the electric wire W, the exterior member 30, and the urging member 50 can be minimized.

The actual value of the radius r of the cross section may not coincide with the theoretical values for realizing the above Formulas (1) and (2). For example, in the urging member 50, the radius r of the cross section may slightly deviate from the theoretical value due to manufacturing tolerance or the like. In this case, the radii of the curved portions 33 and 34 to be formed may deviate from the target radii R1 and R2. In other words, the diameters of the curved portions 33 and 34 may be deviated with respect to the first distance L1 and the second distance L2.

Even when the radius r of the actual cross section coincides with the theoretical value, the radii of the curved portions 33 and 34 to be formed may be different from the target radii R1 and R2. That is, when the urging member 50 is folded back, the radii of the actually formed curved portions 33 and 34 may deviate from target sizes.

In the urging member 50, the radius r of the cross section may be different at different positions in the axis direction Ax. For example, the urging member 50 may be provided with a first portion forming the fully closed curved portion 33 and a second portion forming the fully open curved portion 34. In this case, the radius r of the cross section of the first portion may be a value that realizes Formula (2). The radius r of the cross section of the second portion may be a value that realizes Formula (1).

As described above, the slide body 210 of the present embodiment moves in the vehicle vertical direction Y in addition to the vehicle front-rear direction X between the fully closed position where the opening 120a is closed and the fully open position where the opening 120a is opened. The distance to the second end portion 30b from the first end portion 30a along the vehicle vertical direction Y at the fully closed position is the first distance L1. The distance to the second end portion 30b from the first end portion 30a along the vehicle vertical direction Y at the fully open position is the second distance L2 different from the first distance L1.

The urging member 50 is configured to have a curved portion of a curved shape having the first distance L1 as a diameter, or is configured to have a curved portion of a curved shape having the second distance L2 as a diameter. The urging member 50 may be configured to be able to have both the curved portion 33 having the diameter of the first distance L1 and the curved portion 34 having the diameter of the second distance L2.

The illustrated urging member 50 is a plate-like member. The cross-sectional shape of the urging member 50 orthogonal to the axis direction Ax of the urging member 50 is an arc shape. The value of the radius r of the arc shape is determined such that the urging member 50 has a curved shape having the first distance L1 as a diameter when the urging member 50 is folded back, or such that the urging member 50 has a curved shape having the second distance L2 as a diameter when the urging member 50 is folded back.

When a value in which the urging member 50 forms a curved shape having the diameter of the first distance L1 is used as the value of the radius r, the exterior member 30 and the electric wire W can be minimized. When a value in which the urging member 50 forms a curved shape having the diameter of the second distance L2 is used as the value of the radius r, the bending R of the exterior member 30 can be set to the maximum size corresponding to the distance L.

The means for forming the curved portion having the predetermined radius in the urging member 50 is not limited to use of the value of the radius r of the cross section. For example, the urging member 50 may include a main body and a regulating portion that regulates a shape of a curved portion formed in the main body. As an example, the regulating portion of the urging member 50 may be formed of a superelastic alloy. In this case, in the main body of the urging member 50, a regulating portion that provides a curved shape with a radius R1 may be disposed in a portion of the curved portion 33. In the main body of the urging member 50, a regulating portion that provides a curved shape with a radius R2 may be disposed in a portion of the curved portion 34. The main body of the urging member 50 can generate a repulsive force in the vehicle vertical direction Y while the curved shape is regulated by the regulating portion.

The content disclosed in the above embodiments and modifications can be appropriately combined and executed.

The routing structure according to the present embodiment includes an urging member that forms a curved portion curved in the vehicle front-rear direction between the first end portion and the second end portion of the exterior member. According to the routing structure of the present embodiment, there is an effect that the shape of the exterior member can be stabilized by the urging member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixing portion fixed to a vehicle body of a vehicle;
a second fixing portion fixed to a slide body that moves along a vehicle front-rear direction at an opening provided in a roof of the vehicle body;
an exterior member having a first end portion held by the first fixing portion and a second end portion held by the second fixing portion;
an electric wire disposed inside the exterior member; and
an urging member disposed inside the exterior member and having a curved portion curved in a vehicle front-rear direction between the first end portion and the second end portion of the exterior member.

2. The routing structure according to claim 1, wherein
the slide body moves in a vehicle vertical direction in addition to the vehicle front-rear direction between a fully closed position where the slide body closes the opening and a fully open position where the slide body opens the opening,
a distance to the second end portion from the first end portion at the fully closed position along the vehicle vertical direction is a first distance,
a distance to the second end portion from the first end portion at the fully open position along the vehicle vertical direction is a second distance different from the first distance, and
the urging member has the curved portion having a curved shape whose diameter is the first distance, or has the curved portion having a curved shape whose diameter is the second distance.

3. The routing structure according to claim 2, wherein
the urging member is a plate-like member,
a cross-sectional shape, of the urging member, orthogonal to an axis direction of the urging member is an arc shape, and
a radius value of the arc shape is determined such that the urging member has a curved shape having the first distance as a diameter when the urging member is folded back, or determined such that the urging member has a curved shape having the second distance as a diameter when the urging member is folded back.

4. The routing structure according to claim 1, wherein
the urging member is located radially inside relative to the electric wire at the curved portion.

5. The routing structure according to claim 1, wherein
the routing structure includes the two urging members, and
one of the urging members is located radially inside relative to the electric wire, and the other of the urging members is located radially outside relative to the electric wire at the curved portion.

6. The routing structure according to claim 1, wherein
the urging member is located radially outside relative to the electric wire at the curved portion.
